(19) United States
(12) Patent Application Publication
(10) Pub. No.: US 2004/0039652 A1
(43) Pub. Date: Feb. 26, 2004

(54) Automated requesting system

(76) Inventor: Christopher Patrick Tighe, Arlington, VA (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/363,734

(22) PCT Filed: Sep. 7, 2001
(86) PCT No.: PCT/US01/27696

(51) Int. Cl. G06F 17/60

(52) U.S. Cl. 705/26

(57) ABSTRACT

An automated requesting system that processes shipping information (FIG. 1), which comprises receiving a request for a product at a processing location (110); generating a report that includes shipping information and identifying information of the product based on the received request; and automatically transmitting the report to a shipper location (107) for shipping of the product.

### REFERENCE TO RELATED APPLICATIONS

This application claims the benefit of priority under 35 U.S.C. §119 from co-pending prior provisional application Serial No. 60/231,321, filed Sep. 8, 2000 for “AUTOMATED ORDERING SYSTEM,” which is incorporated herein by reference.

### DESCRIPTION OF THE INVENTION

1. Field of the Invention

This invention relates to processing shipping information, more particularly, to automating the processing of shipping information using a system.

2. Background of the Invention

A business that sells products often must transport products from a warehouse to a customer's specified address, e.g., a home or business. After a sale and before the recipient receives the product, the business must contact a warehouse that stores the product and contact a delivery service to pick-up and process the product for delivery. The delivery service must determine the size of the product in the request to efficiently dispatch delivery vehicles to pick-up and transport the products. Each of these stages may require a manual process to enter the pick-up and destination address of the product, and to enter relevant information concerning the product to be transported. The business may also maintain and update a customer service database with the sales information in the request to serve the customer. At each manual step, time may be lost in efficiently transporting the product, and human error can lead to inefficient allocation of resources.

A business may have a sales team who sells products “on the road,” that is, away from a sales office. A sales team member calls, emails, or faxes a request back to the sales office. Another employee creates shipping labels for the request and calls a warehouse regarding the request. An employee at the warehouse calls the United States Postal Service (“USPS”) district office to request pick-up of the request. The employee at the warehouse may also use a computer to create shipping labels used during shipping. This process involves reentering relevant shipping information at regular stages along the shipping process.

In another scenario, a customer may buy a product over the Internet using an automated requesting process. This will also require the warehouse that stores the products to contact the delivery service to pick-up the request.

It is accordingly desirable to automate requesting and shipping procedures.

### SUMMARY

In accordance with the invention, a method for processing shipping a physical object is claimed, comprising receiving a request for a product at a processing location; generating a report that includes shipping information and identifying information of the product based on the received request; and automatically transmitting the report to a shipper location for shipping of the product.

It is to be understood that both the foregoing general description and the following detailed description are exemplary and explanatory only and are not restrictive of the invention, as claimed. The accompanying drawings, which are incorporated in and constitute a part of this specification, illustrate one embodiment of the invention and together with the description, serve to explain the principles of the invention.

### BRIEF DESCRIPTION OF THE DRAWINGS

FIG. 1 illustrates a system in which embodiments consistent with the present invention may be implemented;

FIG. 2 illustrates a more detailed view of the server shown in FIG. 1;

FIG. 3 illustrates a flowchart in accordance with embodiments consistent with the present invention; and

FIG. 4 illustrates a possible embodiment of label information.

### DESCRIPTION OF THE EMBODIMENTS

Reference will now be made in detail to an embodiment consistent with the invention, an example of which is illustrated in the accompanying drawings. Wherever possible, the same reference numbers will be used throughout the drawings to refer to the same or like parts.

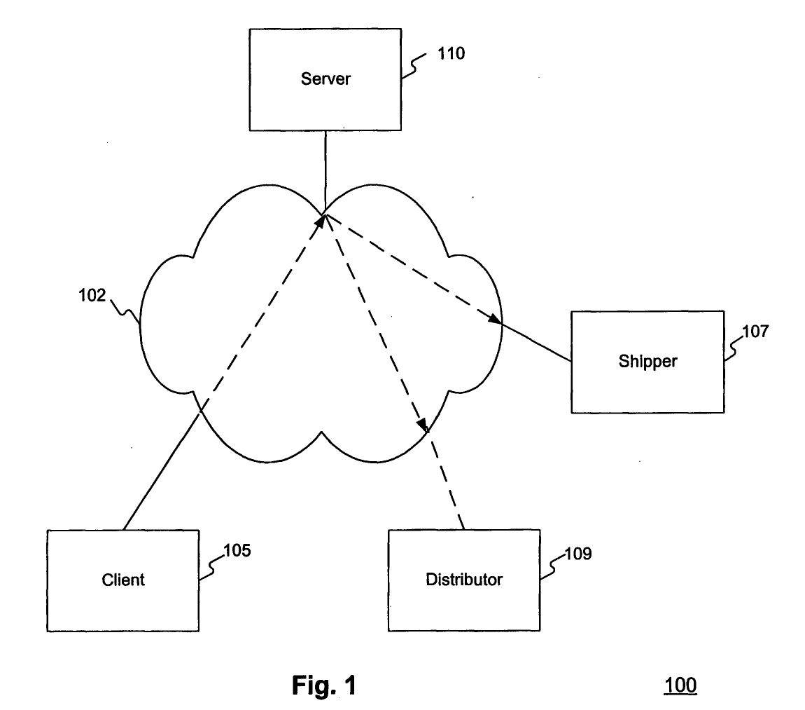

FIG. 1 illustrates a system 100 in which embodiments consistent with the present invention may be implemented. System 100 includes a client computer 105, a shipper client computer 107, a distributor client computer 109, and a server computer 110 connected across a network 102. Network 102 may be, for example the Internet, a wide area network, or local area network. System 100 may also include multiple networks. Although client 105, shipper client 107, and distributor client 109, are described as interconnected to server 110 via network 102, they may also be interconnected via separate networks. Each device may be connected to network 102 in a variety of ways, including but not limited to, an Ethernet connection, a wireless technology, or a cable modem. For example, each device may be interconnected via other intermediate devices or network elements, such as a hub, router, switch, firewall, etc. Although the invention is described with respect to a system interconnection, it is equally applicable to a connection of two or more computers.

Client 105

A user (not shown) may use client 105 at a requesting location to enter a request for a product to be shipped. The user may be a consumer, a seller, an agent for a seller, or some other individual. A requesting location may be, for example, a personal computer in an individual's home, a workstation in a retail store front operated by a store employee, a portable computer operated by a member of a sales team who conducts sales away “on the road,” or any place client 105 can transmit data to server 110. A product may be, for example, a bag of corn, a skirt, a book, or any physical object. Client 105 transmits the request to server 110. The request may include, for example: an identification—e.g., style number—of a product to be shipped; the weight and size of the product to be shipped; pick-up information—e.g., the physical address of the product from where it is to be shipped; destination information for the product to be shipped; the type of delivery service desired; and other information that enables shipping of a product. The request may also be supplemented with information from a variety of sources. For example, a destination address stored in memory at server 110 may be added to the request, using the destination information. Client 105 may also provide customer service information to server 110 in addition to the request. For example, the customer service information may include the name and address of the customer, the name of the recipient, the destination location, an identification of the product requested, or the type of delivery service desired.

Client 105 may be implemented using any suitable combination of hardware and software. For example, client 105 may be implemented as a personal computer including a processor, an I/O device, and a memory. The processor may be, for example, a Pentium microprocessor or a SPARC processor. The I/O device may facilitate connecting, for example, a mouse, a monitor, and a keyboard to client 105 or connecting client 105 to network 102. Client 105 may use a web browser such as, Microsoft Internet Explorer or Netscape Communicator. Moreover, client 105 may be implemented in any device capable of transmitting or receiving data, including but not limited to a cellular telephone, an electronic pager, or a personal digital assistant.

Server 110

Server 110 receives the request transmitted from client 105. Server 110 may be located at a processing location, for example, at a seller's place of business, a warehouse, a storage facility, or a remote location to be accessed by another computer. Alternatively, if client 105 and server 110 are located at the same location, client 105 and server 110 may be integrated, thus allowing the user to enter the request directly into server 110. Upon receiving the request, server 110 compiles the received request; generates label information to enable printing of a shipping label; generates a report; updates a database; and determines the nearest shipper to the storage location, and automatically (without human intervention) transmits the report to that shipper.

Server 110 may transmit the label information to distributor client 109 across network 102. Whether the label information is transmitted to distributor client 109 across network 102 may depend on whether server 110 is located at the same location as distributor client 109. If server 110 and distributor client 109 are at the same location, the label information may be provided to distributor client 109 directly, e.g., via a local area network, or server 110 and distributor client 105 may be integrated. If server 110 and distributor client 109 are not at the same location, the label information may be transmitted to distributor client 109 across network 102.

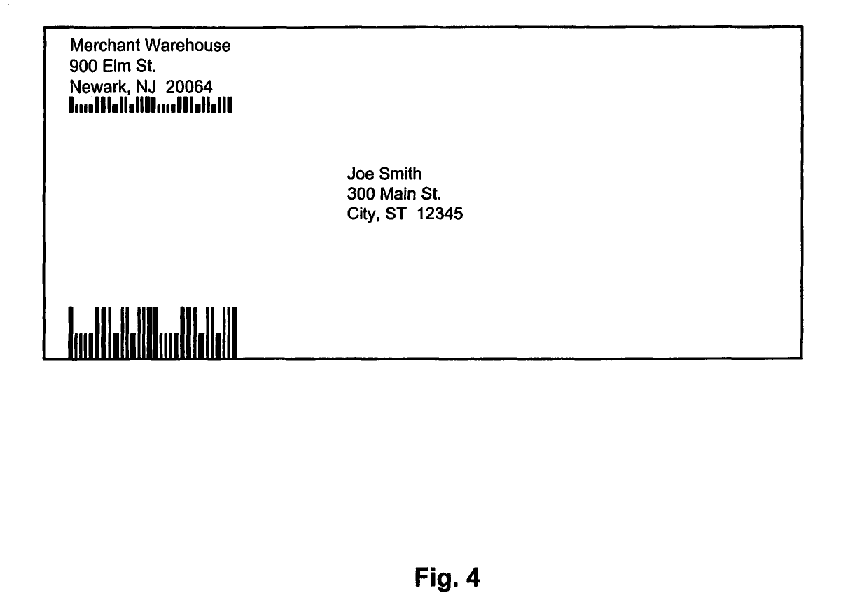

The label information generated by server 110 may include human and machine readable shipping information to enable shipping of a product. The human readable shipping information identifies a particular product style to be shipped, allows a human to associate the label with a particular unit of the identified product, and may include such information as the destination location. The machine readable shipping information allows a machine to recognize the particular unit as the product to be shipped and relevant shipping information, including, but not limited to, the destination location and the type of delivery service. A possible embodiment of the label information is illustrated in FIG. 4.

Server 110 may generate a report and transmit the report to shipper client 107 across network 102, thus enabling a shipping provider, such as the United States Postal Service (“USPS”), to initiate the physical shipment of one or more products referenced in the report. The report generated by server 110 may include information for one or more labels, as well as additional information. That is, the report allows the shipping provider to identify at least the particular unit and pick-up location of the unit, and may identify the destination location, the type of delivery service, and resources needed—e.g., size of truck—to ship the product. The report may also be verified and supplemented by the information provided in the label, which the shipping provider may scan after the product has been provided to the shipping provider.

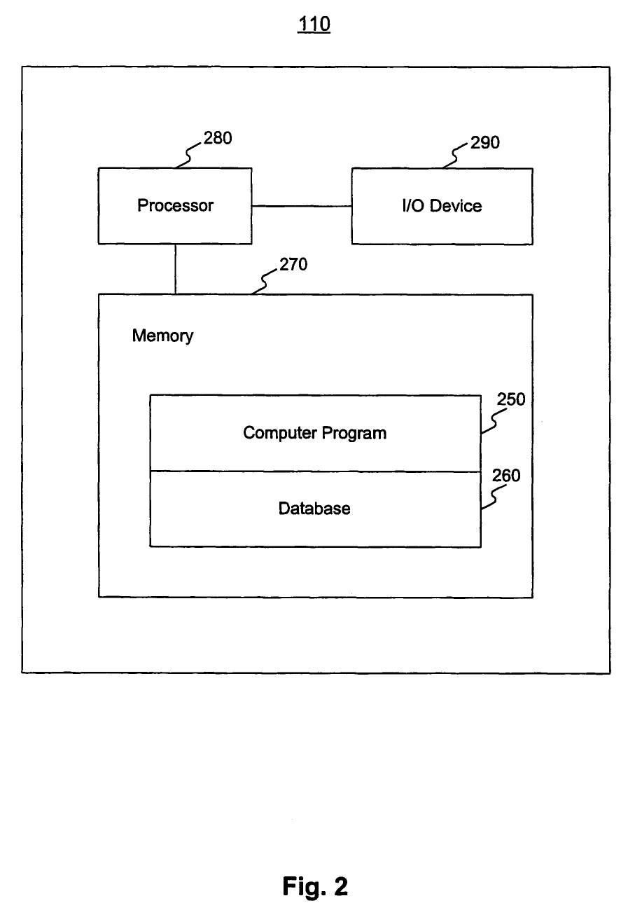

Server 110 may be implemented in any suitable combination of hardware and software. One possible embodiment may be found below with reference to FIG. 2.

Shipper Client 107

Shipper client 107 receives the report transmitted from server 110. Shipper client 107 may determine resource information for delivery of the product based on information provided in the report, such as the pick-up location of a product, destination location, identifying description of the product, and the size and weight of the product to be shipped. The resource information may include the size of a vehicle needed to pick-up and retrieve one or more products with an associated label, the necessary manpower to load the vehicle, and an estimated amount of time to complete the task. Shipper client 107 may receive the report at a shipper location, which may be, for example, the shipping service's place of business or a remote location accessed by a computer located at the place of business.

Shipper client 107 may be implemented using any suitable combination of hardware and software. For example, shipper client 107 may be implemented as a personal computer or workstation including a processor, an I/O device, and a memory. The processor may be, for example, a Pentium microprocessor or a SPARC processor. The I/O device may facilitate connecting, for example, a mouse, a monitor, and a keyboard to shipper client 107 or connecting shipper client 107 to network 102.

Distributor Client 109

Distributor client 109 receives the label information transmitted from server 110 and prints a label based on the received information. Distributor client 109 may receive the label information at a storage location, which may be a distributor's place of business or a remote location accessed by another computer located at the place of business.

Distributor client 109 may be implemented using any suitable combination of hardware or software. For example, distributor client 109 may be implemented as a computer including a processor, an I/O device, and a memory. The processor may be, for example, a Pentium microprocessor or a SPARC processor. The I/O device may facilitate connecting, for example, a mouse, a monitor, and a keyboard to distributor client 109 or connecting distributor client 109 to a network 102.

FIG. 2 illustrates a more detailed view of server 110 shown in FIG. 1. As shown in FIG. 2, server 110 comprises a processor 280, an I/O device 290, and a memory 270. Processor 280 may be, for example, a Pentium microprocessor or a SPARC processor and may be used to process data, e.g., data received in a request from client 105. I/O device 290 may facilitate connecting, for example, a mouse, a monitor, and a keyboard to a server, or for connecting server 110 to a network 102. Memory 270 stores a computer program 250 and a database 260, such as a customer service database. Computer program 250 may be stored on a CD-ROM, which is accessed by memory 270.

Computer program 250 may include program code for a web browser to display information on a web page. The program code may be written in, for example, hypertext markup language or extensible markup language. Computer program 250 compiles information received in the request from client 105 to generate a report to transmit to the shipper client 107 and to generate a label to transmit to distributor client 109 to be associated with a product. Computer program 250 may also update database 260. One skilled in the art will recognize that computer program 250 may also be implemented as multiple computer programs.

One skilled in the art will also recognize that components stored in memories of client 105, server 110, shipper client 107, and distributor client 109 may be stored elsewhere in the device or on other devices connected to network 102.

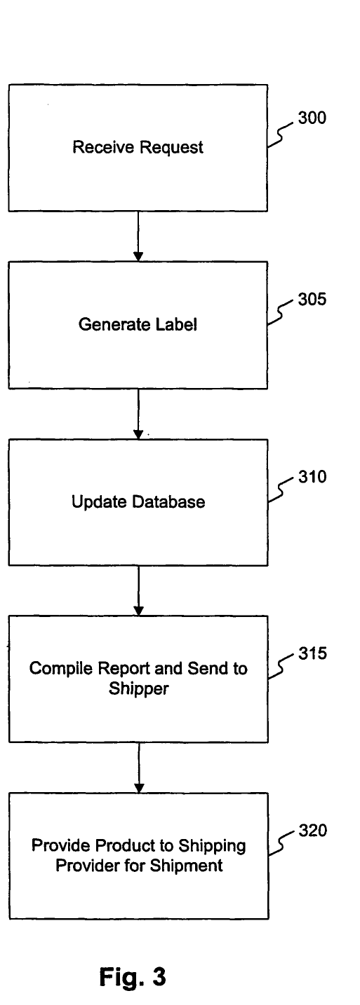

FIG. 3 illustrates a flowchart of a method consistent with the present invention. Client 105 transmits a request to server 110 (step 300). For example, client 105 may connect to server 110 via network 102 to provide the request. A user operating client 105 may browse a web site and select a product to buy—i.e., request a product. Client 105 then transmits that request to server 110 via a web page request. The user operating client 105 may select a product according to any method known to those skilled in the art. Server 110 may also request that client 105 provide shipping information. Although the request is described as being a sales transaction, the request may initiate any transaction that requires shipping a product, for example, a lease of a lawnmower.

Client 105 may transmit the request either remotely or locally (e.g., over the Internet or an intranet, respectively). The request may include shipping information such as an identification of the product to be shipped; the quantity, size, and weight of the product; the destination location of the product; the shipping provider and the type of delivery service desired. The shipping provider may be, for example, the USPS, although the invention is equally applicable to other shipping providers. The type of delivery service may include, for example, Express, overnight, first class, registered, returned receipt requested, or air mail. Additional information may be stored on server 110.

Upon receiving the request from client 105, server 110 generates label information (step 305). That is, server 110 may generate label information by processing the shipping information transmitted in the request and, when appropriate, by processing additional information retrieved from database 260 to generate the label information. The additional information may be retrieved if it is not provided in the request. The additional information stored in database 260 may include the pick-up location of the product to be shipped, the size of the product, the weight of the product, the destination location, and personal information of the addressee. The additional information may also retrieved from elsewhere in memory 270.

Label information may include a bar code that uniquely identifies the product being shipped, identifies the type of service desired, and provides error checking. The bar code associated with a product allows the product to be tracked until delivery at its destination location.

After generating the label information, server 110 transmits the label information to distributor client 109. The label information may be automatically (without human intervention) transmitted to distributor client 109. After distributor client 109 receives the label information, a label based on the received information may be printed. The label may then be associated with the unit of the product to be shipped. For example, associating the label may include attaching the label to a package containing the product to be shipped.

Server 110 may then update database 260 (step 310). Updating database 260 may include storing information provided in the request, such as the name and address of the customer, the name and address of the recipient, the product requested, and the type of delivery service desired. Although steps 305 and 310 are indicated to occur consecutively, they may also occur simultaneously.

Server 110 may compile and transmit a report to shipper client 107 (step 315). The report may be compiled and transmitted instantaneously upon receipt of the request, periodically (including but not limited to, after one minute, after ten minutes, after one hour, or once daily), or upon reaching some preset value (including but not limited to, when the gross weight of a product is equal to or over a fixed weight, when the number of products reaches a particular number greater than or equal to one, when the number of products to be shipped via a specified delivery type reaches a particular number greater than or equal to one, or when a specified monetary value in a product has been reached).

Shipper client 107 allocates resources based on the report, which allows the shipping provider to pick-up one or more products with an associated label from the pick-up location (step 320). The report may indicate the size of a vehicle needed to pick-up and retrieve one or more products with an associated label, the necessary manpower to load the vehicle, and an estimated amount of time to complete the task. The shipping provider may then dispatch vehicles accordingly. The shipping provider retrieves one or more products with an associated label from the pick-up location. The shipping provider may return to a central shipping and distribution center with one or more products, each having an associated label to scan and to distribute further one or more products with an associated label according to type of delivery service desired and destination location. For example, packages labeled for Express service will be properly sorted for faster delivery than those packages designated for normal service.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for processing information for shipping a product, comprising:
transmitting a request for a product from a requesting location;
receiving the request at a processing location;
generating a report at the processing location, the report including shipping information and identifying information of the product based on the received request; and
automatically transmitting the report to a shipper location for shipping of the product.

2. The method of claim 1 wherein the report further comprises information stored at the processing location.

3. The method of claim 1, further comprising determining the resources needed to ship at a processing location based on the received request.

4. The method of claim 1, wherein the generating a report step is performed once per day.

5. The method of claim 1, further comprising updating a database at a processing location based on the received request.

6. The method of claim 1, wherein the generating step further comprises generating the report based on additional information stored in memory at the processing location.

7. The method of claim 1 further comprising generating label information at the processing location, the label information including human readable and machine readable shipping information, and automatically transmitting the label information to a storage location for shipping of the product.

8. The method of claim 7 further comprising printing a label based on the label information received at the storage location; and associating the label with the requested product.

9. The method of claim 7, wherein the generating label information step further comprises generating label information based on additional information stored in memory at the processing location.

10. A method for processing information for shipping a product, comprising:
receiving a request for a product at a processing location;
generating a report that includes shipping information and identifying information of the product based on the received request; and
automatically transmitting the report to a shipper location for shipping of the product.

11. A method for processing information for shipping a product, comprising;
automatically receiving a report at a shipper location, the report generated at a processing location and including shipping information and identifying information of the product based on a received request for the product at a processing location; and
allocating resources based on the shipping information and identifying information in the received report.

12. A method for processing information for shipping a product, comprising;
automatically receiving label information at a storage location, the label information generated at a processing location and including human readable and machine readable shipping and product identifying information;
accessing the product based on the identifying information; and
preparing the product for shipment in accordance with the label information.

13. A method of processing shipping packages, comprising:
establishing an automated entry system via the Internet;
receiving a plurality of shipping requests via the automated entry system;
determining the size of a resource to efficiently handle the shipping packages represented by the shipping requests; and
allocating the resource to company to ship the packages.

14. A computer-readable medium containing information for controlling a data processing system to perform a method for processing shipping packages, said method comprising the steps of:
automatically receiving a report at a shipper location, the report generated at a processing location and including shipping information and identifying information of the product based on a received request for the product at a processing location;
allocating resources based on the shipping information and identifying information in the received report.

15. A processing shipping packages system, comprising:
a memory having program information; and
a processor responsive to the program information to: automatically receiving a report at a shipper location, the report generated at a processing location and including shipping information and identifying information of the product based on a received request for the product at a processing location; allocating resources based on the shipping information and identifying information in the received report.
